(19) United States
(12) Patent Application Publication
(10) Pub. No.: US 2017/0087739 A1
(43) Pub. Date: Mar. 30, 2017

(54) TREATMENT OF HARDWOOD ARTICLES WITH COPPER AND/OR ZINC WOOD PRESERVATIVES

(71) Applicant: Arch Wood Protection, Inc., Atlanta, GA (US)

(72) Inventors: Roger Franklin FOX, Fayetteville, GA (US); Norman Timothy CAREY, Greensboro, GA (US); Randall Thomas BAILEYS, Fayetteville, GA (US)

(21) Appl. No.: 15/374,140

(22) Filed: Dec. 9, 2016

Related U.S. Application Data
(63) Continuation of application No. 13/545,712, filed on Jul. 10, 2012.
(60) Provisional application No. 61/507,832, filed on Jul. 14, 2011.

(51) Int. Cl. B27K 3/20; B27K 3/28; E01B 3/44; B27K 3/08; B27K 3/34; E01B 3/02; B27K 3/22; B27K 3/52

(52) U.S. Cl. CPC B27K 3/20; B27K 3/22; B27K 3/28; B27K 3/52; B27K 3/08; B27K 3/343; E01B 3/02; E01B 3/44; B27K 2240/20

(57) ABSTRACT

Disclosed is process of preserving hardwoods with ammoniacal copper, ammoniacal zinc or ammoniacal copper and zinc compounds. The preserved hardwoods are useable as various articles of manufacture and, in particular, railroad crossties and switch ties.

### CROSS-REFERENCE TO RELATED APPLICATIONS

This is a continuation of U.S. patent application Ser. No. 13/545,712, filed Jul. 10, 2012, which claims the benefit of priority under 35 USC §119(e) to provisional patent application Ser. No. 61/507,832, filed on Jul. 14, 2011, each of which is incorporated herein by reference.

### FIELD OF THE INVENTION

The present invention relates to a method of treating articles of manufacture with ammoniacal copper, ammoniacal zinc and/or ammoniacal copper and zinc wood preservatives.

### BACKGROUND OF THE INVENTION

Preservative treatment of railroad crossties and switch ties to prevent insect and fungal attack has a history dating more than 125 years. During this time, the predominant preservative of choice has been creosote, which is typically mixed with coal tar and heavy petroleum liquids. The treatment process includes vacuum-pressure cycles, whereby the creosote solution is applied into the void spaces of the ties. Although the use of creosote remains as the major wood preservative for crossties and switch ties, environmental concerns, as well as cost, alternative methods of preserving railroad crossties and switch ties wood are needed.

Presently, the American Wood Protection Association (AWPA) has approved creosote for treatment of about a dozen wood species. Another organic solvent based preservative, pentachlorophenol (PCP), has been approved for the same wood species. However, as with creosote, the environmental issues and cost are major factors in selecting a preservative system for treatment of crossties and switch ties. Another, more environmentally friendly, hydrocarbon based wood preservative is copper naphthenate. Although it is approved for the treatment of many wood species, it is high in cost compared to creosote and PCP. The only approved inorganic based preservative for treatment of crossties and switch ties is ammoniacal copper zinc arsenate (ACZA) at retention of 0.40 lbs ACZA oxides per cubic foot. However, ACZA is only approved for only three wood species: Coastal Douglas-fir, Western Hemlock and Western Larch.

There are many alternative wood preservatives available in the market but they are used mostly for treatment of lumber and other small stock, not for crossties or switch ties. Although these preservatives can be used to treat many species, such as pine, spruce and firs; there is no suggestion to use these treatments with white oak.

For example, U.S. Pat. No. 4,038,086 discloses a method for the preparation of ammoniacal copper preservative composition comprised of ammoniacal copper zinc arsenate (ACZA) and the treatment of wood products, specifically, white spruce. The ACZA preservative solution retention was reported to be 12 to 19 pounds per cubic foot with penetration of 0.35 to 2.1 inches in the sapwood of round stock.

U.S. Pat. No. 4,929,454 discloses an ammoniacal copper plus a quaternary ammonium compound composition (ACQ) and its use in the treatment of Red Pine and Douglas-fir. The ACQ formulation was used to vacuum pressure treat 2″×2″×22″ end sealed boards of Red Pine and Douglas-fir. Preservative penetration measurements showed that the copper content at the 1 inch depth was about 48% and 58% for the Red Pine and Douglas-fir, respectively, when compared to the copper at the surface of the board.

Crossties and switch ties on the East Coast of the United States are typically made from two wood species: red oak (Quercus rubra) and sweet gum (Liquidambar styraciflua). However, during harvesting of the oak trees, white oak (Quercus alba) is also harvested and is mixed with the red oak. As such, the untreated oak crossties and switch ties is generally a mixture of both red oak and white oak. Generally, white oak constitutes approximately 15 percent and red oak about 33 percent of all hardwood lumber produced. Thus, the potential average number of white oak crossties and switch ties that could be mixed with red oak ties could be as high as about 30 percent. None of the traditional oil based preservatives such as creosote or PCP can adequately penetrate into the white oak ties. This results in premature decay and failure of these ties, especially in the southeastern United States or other high decay hazard (Zone 5) areas. Therefore, commercial tie treaters will typically “hand separate” these white oak ties prior to treatment of the red oak and sweet gum ties. This practice is costly and resource intensive.

There is a need in the art to effectively preserve hardwood crossties and switch ties, in particular, hardwood crossties and switch ties that contain white oak as the hardwood.

### SUMMARY OF THE INVENTION

It has been discovered that hardwoods can be effectively treated with an ammoniacal copper compound, ammoniacal zinc compound, ammoniacal copper and zinc compound containing preservative that overcomes the problems of treating hardwoods, in particular, hardwoods containing mixed woods, including white oak.

Provided is a method of preserving hardwoods. The method contains the steps of placing the hardwoods in a treating vessel; supplying a preservative composition comprising an ammoniacal compound selected from the group consisting of ammoniacal copper compound, an ammoniacal zinc compound, an ammoniacal copper and zinc compound and a mixture thereof to the treating vessel so that the preservative composition will contact a least one surface of the hardwoods; and penetrating the preservative composition below the surface of the hardwoods.

Also provided is a method of treating hardwood railroad crossties and hardwood railroad switch ties containing a mixture of hardwoods. The method contains the steps of placing the hardwood railroad crossties and/or hardwood railroad switch ties in a treating vessel; supplying a preservative composition comprising an ammoniacal compound selected from the group consisting of ammoniacal copper compound, an ammoniacal zinc compound, an ammoniacal copper and zinc compound and a mixture thereof to the treating vessel so that the preservative composition will contact a least one surface of the hardwood railroad crossties and/or hardwood railroad switch ties, and penetrating the preservative composition below the surface of the hardwood railroad crossties and/or hardwood railroad switch ties.

### DETAILED DESCRIPTION OF THE INVENTION

The present invention, generally stated, relates provides a method of treating hardwoods with a preservative composition containing ammoniacal copper composition, ammoniacal zinc composition, ammoniacal copper and zinc composition containing preservative. It has been discovered that hardwoods, in particular difficult to treat oak, and more particularly white oak, can be treated with the preservative composition can be effect means of preserving the hardwood.

Hardwoods that may be treated by the preservative composition, including, but not limited to sweet gums, oaks (red oak, white oak) and the like. Oaks tend to be more difficult to treat and white oak can be very difficult to treat. There are eight different species of oak that are typically classified as “white oak”. These species consist of White Oak (Quercus alba), Bur Oak (Quercus Macrocarpo), Overcup Oak (Quercus lyrata), Post Oak (Quercus stellata), Swamp Chestnut Oak (Quercus michauxii), Chestnut Oak (Quercus prinus), Swamp White Oak (Quercus bicolor) and Chinkapin (Quercus muchlenbergii). The formation of tyloses in white oak is believed to be the cause of the restricted preservative. Tyloses are extensions or balloon-like outgrowths of the parenchyma cell into the lumen of a xylem vessel. After formation, the tyloses become filled with tannins, gums, pigments, etc. Tyloses bulge through the circular bordered pits of vessel members and block liquid movement. The presence of tyloses in white oaks makes wood of the oak watertight and resistant to liquid penetration, and thus resistant to penetration of wood preservative treatments. For this reason, white oak species of hardwood are very difficult to treat with preservative compositions.

Suitable ammoniacal compositions contain ammoniacal copper zinc arsenate (AZCA), an alkaline copper quat with an ammonia additive (ACQ-A, ACQ-B or ACQ-D), a copper azole with an ammonia additive (CBA-A, CA-B, CA-C), a copper naphthenate with an ammonia additive (CuN—W) or a mixture of two or more of these ammoniacal compositions. Of these compositions, one particularly effective ammoniacal composition is an ammoniacal copper zinc arsenate (ACZA). These ammoniacal copper, ammoniacal zinc and ammoniacal copper and zinc compositions are known in the art and are generally prepared by dissolving a copper and/or zinc oxide, hydroxide or carbonate in ammonia containing a suitable amount of an anion, such as a carbonate to dissolve the copper and/or zinc compounds into an aqueous solution.

The preservative is generally an aqueous solution of the ammoniacal copper, ammoniacal zinc or ammoniacal copper and zinc compositions. The preservative will generally contain up to about 10% by weight of the active ingredients of the ammoniacal copper, zinc or copper and zinc composition. Typically, the preservative will contain between about 0.5% and 10% by weight of the active ingredient. More particularly, the preservative contains between 1% and 8% by weight of the active ingredient(s). Generally, when copper is present, it is present as copper (II); however, copper (I) may also be used. The preservative may be supplied to the end user as a concentrate and the end user dilutes the concentrate to the desired active concentration in the ranges specified above.

The active ingredients of each of these ammoniacal compositions are generally set forth by American Wood Protection Association and the active amounts differ for each of the know compositions. For example, ACZA will generally have a composition containing, from about 45-55% of copper as copper oxide (CuO), from about 22.5-27.5% of zinc as zinc oxide and about 22.5-27.5% of arsenic as As₂O₅ based on the total amount of actives in the composition on a molar basis. The composition will generally have ammonium hydroxide (ammonia) in an amount of at least 1.38 times the weight of the copper oxide. Ammonium bicarbonate is present in an amount of at least 0.92 times the weight of copper oxide. Further the composition will contain water in amount to adjust the concentration of the active ingredients in the composition.

Alkaline Copper Quat Type A (ACQ-A) generally contains about 45.5-54.5% copper as CuO and 45.5-54.5% of a quaternary ammonium compound (typically didecyldimethyl ammonium chloride or carbonate base on the active ingredients in the composition. In addition, ACQ-A contains ethanolamine and/or ammonia with the ethanolamine, when present, being present in an amount 2.5-3 times the weight of the CuO in the compositions and ammonia, when present, in amount at least equal to the weight of the CuO in the composition. The composition will generally have a carbonate anion, generally introduced as ammonium carbonate, in an amount equal to at least 25% of the weight of CuO in the composition. Further, the composition will contain water in amount to adjust the concentration of the active ingredients in the composition.

Alkaline Copper Quat Type B (ACQ-B) generally contains about 62-71% copper as CuO and 29-38% of a quaternary ammonium compound (typically didecyldimethyl ammonium chloride or carbonate) base on the active ingredients in the composition. In addition, ACQ-B contains ammonia in amount at least equal to the weight of the CuO in the composition. The composition will generally have a carbonate anion, generally introduced as ammonium carbonate, in an amount equal to at least 65% of the weight of CuO in the composition. Further, the composition will contain water in amount to adjust the concentration of the active ingredients in the composition.

Alkaline Copper Quat Type C (ACQ-C) generally contains about 62-71% copper as CuO and 29-38% of a quaternary ammonium compound (typically C12 and C14 alkyl chain length alkylbenzyldimethyl ammonium compounds) base on the active ingredients in the composition. In addition, ACQ-B contains ammonia in amount at least equal to the weight of the CuO in the composition. The composition will generally have a carbonate anion, generally introduced as ammonium carbonate, in an amount equal to at least 65% of the weight of CuO in the composition. Further, the composition will contain water in amount to adjust the concentration of the active ingredients in the composition.

Alkaline Copper Quat Type D (ACQ-D) generally contains about 62-71% copper as CuO and 29-38% of a quaternary ammonium compound (typically didecyldimethyl ammonium chloride or carbonate) base on the active ingredients in the composition. In addition, ACQ-D contains ethanolamine and/or ammonia with the ethanolamine, when present, being present in an amount 2.5-3 times the weight of the CuO in the compositions and ammonia, when present, in amount at least equal to the weight of the CuO in the composition. The composition will generally have a carbonate anion, generally introduced as ammonium carbonate, in an amount equal to at least 25% of the weight of CuO in the composition. Further, the composition will contain water in amount to adjust the concentration of the active ingredients in the composition.

Copper Azoles are compositions containing copper and an azole compound. Copper Azoles may contain boric acid or may be free of boric acid. Copper Azole with boric acid (CBA-A) generally contains as the active ingredients around 46-54% copper, 46-54% boric acid and 1-3% of an azole, typically tebuconazole and/or propiconazole, based on the active ingredients. The composition is dissolved in ethanolamine or ammonium hydroxide. Compositions free of boric acid generally contain 95-97% copper and from 3-5% of the azole and generally have the designations CA-B and CA-C. Further, the composition will contain water in amount to adjust the concentration of the active ingredients in the composition.

Copper naphthenate with an ammonia additive (CuN—W) contains copper and copper naphthanate as the active ingredients. The composition will also contain ammonia and/or an ethanol amine.

In addition to the ammoniacal composition, the preservative composition further comprises a co-biocide. Suitable co-biocides include, for example, an azole compound, a borate compound, a carbamate compound, a quaternary amine compound, an isothiazolone compound, a diazo compound, a chloronitrile compound, a nicotinoid compound, a pyrethroid compound or a mixture of two or more of these co-biocides. Other ingredients may be added to the preservative composition including an adjuvant. Suitable adjuvants include, compounds such as an amine, an amine oxide, a betaine or a mixture thereof, for example. In addition, the preservative composition may further include an additional metal or metal ion. Suitable metal or metal ions include lead, iron, aluminum, tin, chromium, titanium, manganese, silver or a mixture of two or more of these metals. Particularly useful include didecyl polyoxyethyl ammonium borate (DPAB) and N-cyclohexyl-diazeniumdioxide (HDO).

To aid in the prevention of insect and fungal attack of the crossties, disodium octaborate tetrahydrate (DOT) is often used in conjunction with creosote treatments of crossties. Generally, the DOT was used as dip treatment of crossties prior to treatment with creosote. Surprisingly, it was found that DOT could be added directly to the ammoniacal copper zinc preservative solution and the ties could be treated in a one-step process, not as with creosote where ties were first dip treated with DOT and then treated with creosote. It was also found that DOT addition had no impact on the penetration of ammoniacal copper in White Oak.

To treat the hardwood with the preservative composition, the hardwood is placed in a treating vessel. Typically, the hardwood is dried to a point that the moisture content is less than about 25% in the outer inch of the wood prior to treatment. To achieve the desired moisture content, the hardwood may be air seasoned or dried in a kiln using typical wood drying techniques. Once the wood is in the treating vessel the preservative composition is charged into the treating vessel so that it contacts the surfaces of the hardwood. Next, the preservative composition is penetrated into the hardwood and below the surface of the hardwood.

Generally, the treating vessel is a pressure vessel that is capable of having both low pressures within the vessel and high pressures within the vessel. In addition, the treating vessel should be able to withstand high temperature for an extended period of time and have a chamber size that is capable of the having dimensional lumber contained within chamber.

Once the hardwood is introduced into the chamber of the treating vessel, the hardwood is then subjected to a steam pre-heat for a period of time. Generally, the steam pre-heat will be in the range of about 200° F. to about 250° F. for a period of time up to about 4 hours. Typically, the steam pre-heat is about 1-3 hours. After steam pre-heat, the treating vessel is usually evacuated of moisture and air to draw a vacuum for a period of time. The vacuum is generally conducted for 1-3 hours and is in the range of about 15 inches to about 25 inches of mercury. After the vacuum is released, the preservative composition is placed in the treatment vessel. After the introduction of the preservative composition, the preservative composition is penetrated into the surface of the wood by increasing the pressure in the treatment vessel for a period of time. The pressure treatment is generally in the range of about 100-250 psi for a period of up to 14 hours. Typically, the pressure treatment is for a period of about 6-10 hours and at a pressure in the range of about 150-200 psi.

Surprisingly, it has been discovered that wood species, particularly as white oak, can effectively treated with an ammoniacal preservative composition that will effectively penetrate the wood and have a greater penetration than typically used creosote preservative composition. In addition, the ammoniacal preservative composition is effective to treat other hardwood typically used in railroad crossties and switch ties, including red oak and sweet gum. A result of this discovery is that white oak can be effectively preserved along with red oak and sweet gum and that white oak does not have to be manually separated from the red oak and sweet gum prior to treating the wood for use as railroad crossties and switch ties.

Not wishing to be bound by theory, but it is believed that ammoniacal preservative, more particularly the ammoniacal copper, possibly dissolves lumen sealing outgrowths of the parenchyma cell of the white oak. The ammoniacal composition may interact with the tyloses by interaction or reaction with tannins, gums, pigments etc. the fill the tyloses balloons.

The resulting treated hardwood of the present invention is suitable for various uses including, landscape timbers, railroad crossties, railroad switch ties, utility poles and other similar uses.

### Examples

Four hundred and fifty hardwood crossties, having dimensions of 7 inches×9 inches×102 inches and volume of 3.7 cubic feet, were used in the examples described below. These were comprised of 150 crossties of each wood species: white oak, red oak and sweetgum. The ties were all dried to a moisture content of less than 25 percent in the outer inch of each crosstie.

The moisture content for each species was measured in three zones: 0-1 inch, 1-2 inch and 2-3 inch. These samples were dried to constant weight in a laboratory oven set at 105° C. These measured moisture contents are reported in the Table 1.

TABLE 1
Average Percent Moisture Content
in Various Depths by Oven Drying

| Wood Species | 1″ | 2″ | 3″ |
|---|---|---|---|
| White Oak | 22 | 37 | 45 |
| Red Oak | 16 | 34 | 40 |
| Sweet Gum | 20 | 31 | 36 |

Similar results were obtained using a commercial moisture meter and are reported in Table 1A.

TABLE 1A
Moisture Content Using Moisture Meter

| | | Depth of |
|---|---|---|
| Wood | Moisture, | Measurement, |
| Species | % | Inches |
| white oak | 22 | 0.25 |
| red oak | 16 | 0.50 |
| sweet gum | 20 | 0.50 |

Thirty ties of Coastal Douglas-fir were added to two examples given below for additional information.

### Example 1: Treatment of White Oak, Red Oak and Sweetgum with Creosote

Ten ties of white oak, red oak and sweetgum were all treated in the same treatment charge with creosote by steaming, vacuum pressure methods. This method consisted of a 2 hour steaming period with steam at 230° F., a 2 hour initial vacuum and a 12 hour pressure period at 170 psi.

The resulting creosote treated ties were inspected following AWPA M2-07, Standard for Inspection of Wood Products Treated with Preservatives. Three inch long increment borings were taken from each tie and the depth of preservative penetration was measured. The results for the depth of penetration are given in Table 2.

TABLE 2
Average Penetration of Creosote

| | Average Depth, | Standard Deviation, |
|---|---|---|
| Wood Species | Inches | Inches |
| White Oak | 0.62 | 0.35 |
| Red Oak | 2.35 | 0.68 |
| Sweetgum | 2.18 | 0.80 |

These results for white oak clearly show the lack of preservative penetration by the most commonly used crosstie and switch tie preservative, creosote, and the need to an improved preservative system, capable of preservative penetration in white oak.

### Example 2: ACZA Treatment of White Oak and Red Oak

Fifteen of white oak and 15 ties of red oak were treated using the creosote streaming, vacuum pressure process (5 hours) with a 2.87% ACZA (CuO, ZnO and As₂O₅) treating solution and tested for preservative penetration flowing AWPA Standards M2-07 and A3-08, Section 14 (Standard Methods for Determining Penetration of Preservatives and Fire Retardants). Two inch borings were taken from the treated white oak and 3 inch borings from the treated red oak ties. These borings were tested for penetration using the PAN, 1-(2-pyridyazo)-2-naphthol, copper indicator. The average ACZA solution pickup was measured by weighing the bundled ties before and after treated. The preservative pickup and penetration results are reported in Table 3.

TABLE 3
ACZA Preservative Pickup and Penetration

| | | Average | Standard |
|---|---|---|---|
| Wood | ACZA Solution | Depth, | Deviation, |
| Species | Pickup, lbs/ft³ | Inches | Inches |
| White Oak | 12.7 | 1.49 | 0.52 |
| Red Oak | 9.8 | 2.56 | 0.52 |

When these results are compared to those obtained for creosote in Example 1, one can see that the penetration in white oak increased dramatically, from 0.62 inches to 1.49 inches. This represents an increase of 140% in preservative penetration for white oak but only a 9 percent increase was observed for Red oak.

These borings were further analyzed in the 0 to 0.6 inch and 0.6 to 1.0 inch ranges following AWPA Standard A9-08 (Standard Method for the Analysis of Wood and Wood Treating Solutions X-ray Spectroscopy). The averaged ACZA preservative retention expressed in pounds per cubic foot as determined from these analyses are given in Table 3A. In this case, the white oak actually treated much better than the red oak, which is considered an easier to treat specie.

TABLE 3A
ACZA Retention (pcf) in the 0 to 1.0 Inch Zones

| | 0-0.6 Inch Zone | 0.6-1.0 Inch Zone |
|---|---|---|
| Wood Species | ACZA (pcf) | ACZA (pcf) |
| White Oak | 0.60 | 0.34 |
| Red Oak | 0.43 | 0.25 |

As can be seen, the white oak had an ACZA retention greater than 0.40 pcf to exceed the AWPA requirement for wood species.

### Example 3: ACZA Treatment of White Oak, Red Oak and Sweetgum

Two bundles of ties, consisting of 15 and 20 ties, of white oak, red oak and sweetgum were treated with an ACZA preservative solution having a concentration of 3.25% total oxides. The pressure period was increased to 12 hours. The preservative penetration was measured in 3 inch borings using PAN indicator and the weighed pickup for both bundles of ties was averaged. The ACZA preservative retention and penetration results for 15 ties selected at random from the two bundles are given in Table 4.

TABLE 4
ACZA Preservative Pickup and Penetration
for White Oak, Red Oak and Sweetgum Ties

| | ACZA Solution | Average | Standard |
|---|---|---|---|
| Wood Species | Pickup, lbs/ft³ | Depth, Inches | Deviation, Inches |
| White Oak | 6.9 | 2.09 | 0.69 |
| Red Oak | 14.4 | 2.43 | 0.72 |
| Sweetgum | 28.4 | 2.56 | 0.67 |

The average depth of penetration for the white oak is approximately 240% higher than that of the “standard” tie preservative, creosote (Example 1). While for red oak and sweetgum the increase in preservative penetration was only about 3 and 8%, respectively.

The ACZA preservative retentions were measured by X-ray techniques and are reported as averaged values for the 15 borings. These analyses are given in Table 5.

TABLE 5
ACZA Retention (pcf) in the 0 to 1.0 Inch Zones
for White Oak, Red Oak and Sweetgum

| | 0-0.6 Inch Zone | 0.6-1.0 Inch Zone |
|---|---|---|
| Wood Species | ACZA (pcf) | ACZA (pcf) |
| White Oak | 0.54 | 0.24 |
| Red Oak | 0.58 | 0.32 |
| Sweetgum | 0.86 | 0.49 |

### Example 4: ACZA Treatment of White Oak, Red Oak and Sweetgum

Four bundles of crossties were pressured treated with a 3.18% ACZA solution. These bundles were comprised of 20 crossties of white oak, 20 ties of red oak and two bundles, 15 and 20 ties each, of sweetgum. The pressure period was 12 hours.

Fifteen ties of each ACZA treated wood species were bored and examined for preservative penetration using AWPA Standard A3-08, Section 8, which uses rubeanic acid as the copper indicator. As done in previous examples, the crosstie bundles were weighed before and after ACZA treated to determine the preservative solution pickup. The results of these tests are given in Table 6.

TABLE 6
ACZA Preservative Pickup and Penetration
for White Oak, Red Oak and Sweetgum Ties

| Wood | ACZA Solution | Average | Standard |
|---|---|---|---|
| Species | Pickup, lbs/ft³ | Depth, Inches | Deviation, Inches |
| White Oak | 7.6 | 0.90 | 0.68 |
| Red Oak | 18.1 | 2.57 | 0.51 |
| Sweetgum | 27.5 | 2.52 | 0.52 |

The white oak penetration improvement was somewhat reduced when compared to earlier examples but is still significantly greater than that found for the other species included in this test. Penetration in white oak was ˜45% greater than Example 1, whereas for red oak and sweetgum, the increase in preservative penetration was about 9 and 16%, respectively.

Combining Examples 2 through 4, the increase in preservative penetration compared to creosote was about 140% for white oak, whereas for red oak and sweetgum, the increased penetration is only about 7 and 12%, respectively. This is illustrative of the unique composition of white oak as compared to red oak and sweetgum and the unique ability of ammoniacal preservatives to treat this species.

The ACZA preservative retentions, expressed as ACZA oxides, are showed in Table 7. As with the penetration test, the retention in the white oak is slightly lower than found in previous examples.

TABLE 7
ACZA Retention (pcf) in the 0 to 1.0 Inch Zones
for White Oak, red oak and Sweetgum

| | 0-0.6 Inch Zone | 0.6-1.0 Inch Zone |
|---|---|---|
| Wood Species | ACZA (pcf) | ACZA (pcf) |
| White Oak | 0.47 | 0.24 |
| Red Oak | 0.68 | 0.48 |
| Sweetgum | 0.80 | 0.60 |

### Example 5: ACZA Plus DOT Treatment of White Oak, Red Oak, Sweetgum and Douglas-Fir

In order to provide improved protection against fungal and insect attack of the treated crossties and switch ties, other co-biocides such as boron compounds, azoles, nicotinoids, pyrethroids, diazos, quaternary amines, carbamates and others known to those skilled in art can be added to the present invention. For example, disodium octaborate tetrahydrate (DOT) was added to an ACZA formulation. Fifteen tie bundles of white oak, red oak and sweetgum, along with a 20 tie bundle of Coastal Douglas-fir were treated with a 2.81% ACZA treatment solution, containing 4.0% DOT, and pressed at 190 psi for 12 hours. The treatment process followed that previously described. The solution pickup per cubic foot of tie along with the ACZA and DOT preservative penetration for 15 borings of each species is shown in Table 8.

TABLE 8
ACZA Preservative Pickup and Penetration
for White Oak, Red Oak, Sweetgum and Douglas-fir Ties

| | ACZA Solution | Average | Standard |
|---|---|---|---|
| Wood Species | Pickup, lbs/ft³ | Depth, Inches | Deviation, Inches |
| White Oak | 11.3 | 2.45 | 0.90 |
| Red Oak | 16.0 | 2.15 | 0.62 |
| Sweetgum | 29.1 | 2.63 | 0.57 |
| Douglas-fir | 12.8 | 0.59 | 0.09 |

The percent increase/decrease of ACZA penetration compared to Example 1 was +295% for white oak, −9% for red oak and +21% for sweetgum.

The ACZA and DOT assays in the 0 to 1 inch zones were done using X-ray and ICP methods, respectively, and are reported in Table 9.

TABLE 9
ACZA and DOT Retentions (pcf) in the 0 to 1.0 Inch Zones
for White Oak, Red Oak, Sweetgum and Coastal Douglas-fir

| | 0-0.6 Inch | 0.6-1.0 Inch | 0-0.6 Inch | 0.6-1.0 |
|---|---|---|---|---|
| Wood | Zone ACZA | Zone ACZA | Zone DOT | Inch Zone |
| Species | (pcf) | (pcf) | (pcf) | DOT (pcf) |
| White Oak | 0.48 | 0.22 | 0.42 | 0.24 |
| Red Oak | 0.51 | 0.35 | 0.46 | 0.33 |
| Sweetgum | 0.64 | 0.35 | 0.71 | 0.61 |
| Douglas-fir | 0.45 | 0.10 | 0.46 | 0.11 |

### Example 6: ACZA Plus DOT Treatment of White Oak, Red Oak and Douglas-Fir

Fifteen 15 and 20 tie bundles white oak, 15 and 20 tie bundles of red oak and a 10 tie bundle of Coastal Douglas-fir were treated with a an preservative solution contain 3.05% ACZA oxide and 4.0% DOT. The ties were pressed for 14 hours. The treating cycles used were those previously described. The solution retention per cubic foot of wood along with the penetration data via rubeanic acid for 15 borings for each species is given in Table 10.

TABLE 10
ACZA Preservative Pickup and Penetration
for White Oak, Red Oak and Douglas-fir Ties

| | ACZA Solution | Average | Standard |
|---|---|---|---|
| Wood Species | Pickup, lbs/ft³ | Depth, Inches | Deviation, Inches |
| White Oak | 11.8 | 2.44 | 0.60 |
| Red Oak | 13.6 | 1.62 | 0.76 |
| Douglas-fir | 11.4 | 0.88 | 0.28 |

The increase/decrease in ACZA penetration was +294% in white oak and -31% for red oak when compared to Example 1.

The preservative retention in the 0 to 1.0 inch zones is reported in Table 11.

TABLE 11
ACZA and DOT Retentions (pcf) in the 0 to 1.0 Inch Zones
for White Oak, Red Oak and Coastal Douglas-fir

| | 0-0.6 | 0.6-1.0 | 0-0.6 | 0.6-1.0 |
|---|---|---|---|---|
| Wood | Inch Zone | Inch Zone | Inch Zone | Inch Zone |
| Species | ACZA (pcf) | ACZA (pcf) | DOT (pcf) | (DOT pcf) |
| White Oak | 0.64 | 0.36 | 0.60 | 0.33 |
| Red Oak | 0.52 | 0.20 | 0.31 | 0.17 |
| Douglas-fir | 0.27 | 0.11 | 0.35 | 0.15 |

### Example 7: ACZA Plus DOT Treatment of White Oak and Red Oak

Twenty tie bundles of white oak and red oak were treated as above with a treating solution containing 2.97% ACZA oxides and 4.0 DOT. The pressure period was 14 hours. The solution pickup was measured by weighing the crosstie bundles before and after treatment and ACZA penetration from 15 borings from each wood species was measured using the copper indicator, rubeanic acid. The results of these measurements are given in Table 12.

TABLE 12
ACZA Preservative Pickup and Penetration
for White Oak and Red Oak Ties

| Wood | ACZA Solution | Average | Standard |
|---|---|---|---|
| Species | Pickup, lbs/ft³ | Depth, Inches | Deviation, Inches |
| White Oak | 5.5 | 0.97 | 0.95 |
| Red Oak | 16.6 | 2.20 | 0.85 |

When compared to Example 1, the percent increase in penetration for this AZCA/DOT solution in white oak is +56% and in Red Oak about −6%.

The zone analyses done by ICP techniques for this treatment are given in Table 13.

TABLE 13
ACZA and DOT Retentions (pcf) in the 0 to 1.0 Inch Zones
for White Oak and Red Oak Ties

| | 0-0.6 | 0.6-1.0 | 0-0.6 | 0.6-1.0 |
|---|---|---|---|---|
| Wood | Inch Zone | Inch Zone | Inch Zone | Inch Zone |
| Species | ACZA (pcf) | ACZA (pcf) | DOT (pcf) | (DOT (pcf) |
| White Oak | 0.34 | 0.27 | 0.20 | 0.18 |
| Red Oak | 0.67 | 0.59 | 0.56 | 0.48 |

### Example 8: ACZA Plus DOT Treatment of Sweetgum

Three bundles of sweetgum ties, containing 15, 20 and 20 ties were treated with a 2.44% ACZA preservative solution, containing 3.2% DOT, and pressed for 5 hours. After preservative treatment as described above, the solution pickup per cubic foot of tie along with copper penetration on 15 random borings of the treated ties via rubeanic acid. These results are shown in table 14.

TABLE 14
ACZA Preservative Pickup and Penetration for Sweetgum Ties

| Wood | ACZA Solution | Average | Standard |
|---|---|---|---|
| Species | Pickup, lbs/ft³ | Depth, Inches | Deviation, Inches |
| Sweetgum | 22.7 | 2.25 | 0.61 |

The depth of ACZA penetration is only about 3% more than that of creosote (Example 1). The X-ray and ICP zone analyses done on the borings is shown in Table 15.

TABLE 15
ACZA and DOT Retentions (pcf) in the 0 to 1.0 Inch Zones
for Sweetgum Ties

| | 0-0.6 Inch | 0.6-1.0 | 0-0.6 | 0.6-1.0 |
|---|---|---|---|---|
| Wood | Zone ACZA | Inch Zone | Inch Zone | Inch Zone |
| Species | (pcf) | ACZA pcf) | DOT (pcf) | DOT (pcf) |
| Sweetgum | 0.64 | 0.59 | 0.55 | 0.29 |

As can be seen above, using ammoniacal copper zinc arsenate as the ammoniacal copper based preservative, the penetration of the preservative increased 140% over that found for creosote and had an ACZA preservative retention (0.60 pcf) exceeding 0.40 pcf ACZA for AWPA approved wood species. Also, the ACZA penetration increase over that of creosote was 240% with ACZA retention 0.54 pcf. Further it was showed that a 45% increase in penetration with the ACZA formulation and had an ACZA retention of 0.47 pcf. No dramatic penetration increase was observed for the controls: red oak (9, 3 and 9%) and sweetgum (8 and 16%). Overall there was a 142% increase in penetration with white oak ties and only a 7% and 12% increase with red oak and sweetgum, respectively.

Further, it can be seen in Examples 5-7 that a co-biocide DOT may be added to the preservative treatment composition without adversely affecting the penetration of the ammoniacal preservative composition into the wood.

While the invention has been described above with references to specific embodiments thereof, it is apparent that many changes, modifications and variations can be made without departing from the invention concept disclosed herein. Accordingly, it is intended to embrace all such changes, modifications, and variations that fall within the spirit and broad scope of the appended claims.

We claim:

1. A method of treating tyloses-containing hardwood railroad crossties and tyloses-containing hardwood railroad switch ties containing mixed tyloses-containing hardwoods including white oak heartwood; said method comprising
placing the tyloses-containing hardwood railroad crossties or tyloses-containing hardwood railroad switch ties, both including white oak heartwood, in a treating vessel comprising a pressure vessel;
subjecting the tyloses-containing hardwood railroad crossties or tyloses-containing hardwood railroad switch ties, both including white oak heartwood to steam for a period of time,
subjecting the tyloses-containing hardwood railroad crossties or tyloses-containing hardwood railroad switch ties, both including white oak heartwood, to a vacuum for a period of time,
supplying a preservative composition comprising an ammoniacal compound including ammoniacal copper zinc arsenate to the treating vessel so that the preservative composition will contact a least one surface of the tyloses-containing hardwood railroad crossties or tyloses-containing hardwood railroad switch ties, both including white oak heartwood, and
penetrating the preservative composition below the surface of the tyloses-containing hardwood railroad crossties or tyloses-containing hardwood railroad switch ties, both including white oak heartwood, in an amount sufficient to inhibit insect and fungal attacks at an average depth of at least 0.5 inches as determined following American Wood Protection Association M2-07 Standard,
wherein penetrating the preservative composition into the tyloses-containing hardwood railroad crossties or tyloses-containing hardwood railroad switch ties, both including white oak heartwood, comprises applying pressure to the treating vessel containing the tyloses-containing hardwood railroad crossties or hardwood railroad switch ties, both including white oak heartwood, and the preservative composition for a period of time.

2. The method according to claim 1, wherein the ammoniacal compound contains copper (II).

3. The method according to claim 2, wherein the ammoniacal compound further comprises an alkaline copper quat, an copper azole with an ammonia additive, a copper naphthenate with an ammonia additive or a mixture of two or more of these ammoniacal compounds.

4. The method according to claim 1, wherein the preservative composition further comprises a co-biocide.

5. The method according to claim 4, wherein the co-biocide comprises an azole compound, a borate compound, a carbamate compound, a quaternary amine compound, an isothiazolone compound, diazo compound, a chloronitrile compound, a nicotinoid compound, a pyrethroid compound or a mixture of two or more of these co-biocides.

6. The method according to claim 4, wherein the co-biocide comprises disodium octaborate tetrahydrate, didecyl polyoxyethyl ammonium borate or N-cyclohexyl-diazeniumdioxide.

7. The method according to claim 1, wherein the preservative composition further comprises an adjuvant.

8. The method according to claim 7, wherein the adjuvant comprises an amine, an amine oxide, a betaine or a mixture thereof.

9. The method according to claim 1, wherein the preservative further comprises an additional metal or metal ion.

10. The method according to claim 9, wherein the metal or metal ion comprises lead, iron, aluminum, tin, chromium, titanium, manganese, silver or a mixture of two or more of these metals.

11. The method according to claim 1, wherein the white oak heartwood comprises Quercus alba.

12. The method according to claim 1, wherein the white oak heartwood is a specie selected from the group consisting of Quercus Macrocarpa, Quercus lyrata, Quercus stellata, Quercus michauxii, Quercus prinus, Quercus bicolor and Quercus muchlenbergii.

13. The method according to claim 1, wherein the tyloses-containing hardwood railroad ties including the white oak heartwood contains a blend of white oak and red oak.

14. The method according to claim 1, wherein
the period of time for subjecting the tyloses-containing hardwood crossties and switch ties, including the white oak heartwood, to steam is between about 1 and about 3 hours;
the period of time for subjecting the tyloses-containing hardwood, including the white oak heartwood, to a vacuum is between about 1 and about 3 hours; and
the period of time for applying pressure to the pressure vessel containing the tyloses-containing hardwood, including the white oak heartwood, and the preservative composition is between about 3 to about 18 hours.

15. Treated hardwood railroad crossties and switch ties prepared by the method according to claim 1.

16. The method according to claim 1, wherein the average depth is at least 0.62 inches.

17. The method according to claim 16, wherein the average depth is at least 0.90 inches.

18. The method according to claim 17, wherein the average depth is at least 1.49 inches.
